(19) United States
(12) Patent Application Publication
(10) Pub. No.: US 2005/0021451 A1
(43) Pub. Date: Jan. 27, 2005

(54) System and method for providing access to debt payment information

(76) Inventors: Kian Khalooghli, Newport Coast, CA (US); Shahram Nazari, Tustin, CA (US)

Correspondence Address: IRELL & MANELLA LLP, 840 NEWPORT CENTER DRIVE, SUITE 400, NEWPORT BEACH, CA, 92660, US

(21) Appl. No.: 10/626,202

(22) Filed: Jul. 22, 2003

(51) Int. Cl. G06F 17/60

(52) U.S. Cl. 705/38

(57) ABSTRACT

Disclosed is a system and method that centralizes debt payoff information such that the payoff information may be efficiently accessed at any time. In one embodiment, financial institutions and/or consumers are provided with the ability to access their current payoff information, where such payoff information may relate to homes, cars, motorcycles, boats, etc. In one embodiment, financial institutions provide payoff information for their customers to a central database. In another embodiment, this payoff information further includes details about the debtor, as well as the date until which the payoff information is accurate (as in the case of an interest-accruing obligation).

### BACKGROUND OF THE INVENTION

1. Field of the Invention

The present invention relates in general to debt payoff information and more particularly, to a system and method for providing access to up-to-date debt payment information.

2. Background of the Invention

When a consumer desires to make a purchase that requires the satisfaction of a pre-existing obligation, there is no current centralized method for obtaining payoff information and related loan/lease details. Moreover, the financial institution which holds the note underlying the obligation in question typically observes traditional business hours. Thus, there is no current method for obtaining such up-to-date payoff information during non-traditional business hours.

For example, a consumer desiring to purchase or lease a vehicle over a weekend or holiday will typically need to provide the car dealer with payoff information in order to trade in their current vehicle as part of the transaction. Currently the car dealer is required to call the specific financial institution which holds the note on the vehicle that is to be traded in. Not only is this an inefficient process since there are thousands of lending institutions across the country, but, in many cases, such information cannot be obtained during non-traditional business hours.

When payoff information is not available, the consumer will often have to estimate what is owed on their current vehicle. Often, such estimations of payoff amount are incorrect and less than what is actually owed. Where the loan/lease payoff amount is estimated, the consumer, in addition to signing a new vehicle lease/purchase contract, is also required to sign a contract stating that he/she will be responsible for any deficiency between the estimated payoff amount and actual payoff amount.

Relying on inaccurate payoff information may leave the vehicle dealer with an unfavorable, or even unprofitable, transaction. Where the actual payoff amount is more than the estimated payoff amount, which may be in the thousands, the dealer must contact the consumer to recoup the deficiency. In many instances, the consumer is not willing to pay any additional amount or renegotiate the loan/lease contract. In such cases, the dealer must resort to legal action against the consumer in order to recoup the loss or write off the loss. Even if successful, the vehicle dealership may nevertheless incur costs associated with this recovery process.

Where the actual payoff amount is less than the estimated payoff amount, the dealer is required to send a check to the consumer for the difference. Such a process is inefficient because, at the very least, it is an additional accounting burden on the dealer.

### BRIEF SUMMARY OF THE INVENTION

System and method for providing access to debt payment information are disclosed. In one embodiment, a server includes a database that contains loan payoff information of a plurality of debtor's. The loan payoff information may be periodically uploaded to the database by financial institutions. The loan payoff information may include the debtor's name, loan number, loan amount, and a date until which the payoff amount is accurate. Entities such as dealers may access the loan payoff information of a debtor, optionally with the debtor's consent, at any time to obtain the current loan payoff amount.

Other embodiments are disclosed and claimed herein.

### BRIEF DESCRIPTION OF THE DRAWINGS

FIG. 1 illustrates one embodiment of a system in which access to debt payment information may be provided;

FIG. 2 illustrates a block diagram of a computer system that may be utilized, according to on or more embodiments disclosed herein;

FIG. 3 depicts one embodiment of a flow diagram for providing information to a centralized database;

FIG. 4 illustrates one embodiment of a centralized database that may be used in the process of FIG. 3; and

FIG. 5 depicts one embodiment of a flow diagram for accessing information from the centralized database of FIG. 4.

### DETAILED DESCRIPTION OF EXEMPLARY EMBODIMENTS

One aspect of the present disclosure is to implement a system that centralizes up-to-date debt payoff information so that such information may be efficiently accessed at any time. In one embodiment, financial institutions and/or consumers are provided with the ability to access their current payoff information for loans, leases, etc. Such payoff information may relate to cars, motorcycles, homes, boats, etc. While it should be appreciated that payoff information for any kind of debt may be accessed, being able to obtain current, up-to-date payoff information for interest-accruing debt at anytime is particularly useful since the amount of the obligation periodically changes.

In one embodiment, financial institutions regularly or periodically provide loan payoff information for their customers to a central database. This may be accomplished by way of dedicated private lines or over a network, such as the Internet. In one or more embodiments, this payoff information includes details about the debtor's loan, as well as the date until which the payoff information is accurate (as in the case of an interest-accruing obligation).

Once the loan information is stored or cached in the central database, it may be accessed via a network connection (e.g., the Internet) or via telephone, e.g., by using a menuing system. Access to the central database may be limited to authorized personnel only, which may include the consumer, authorized retailers, and the like. This may be accomplished by requiring the inquiring entity to enter a password or PIN.

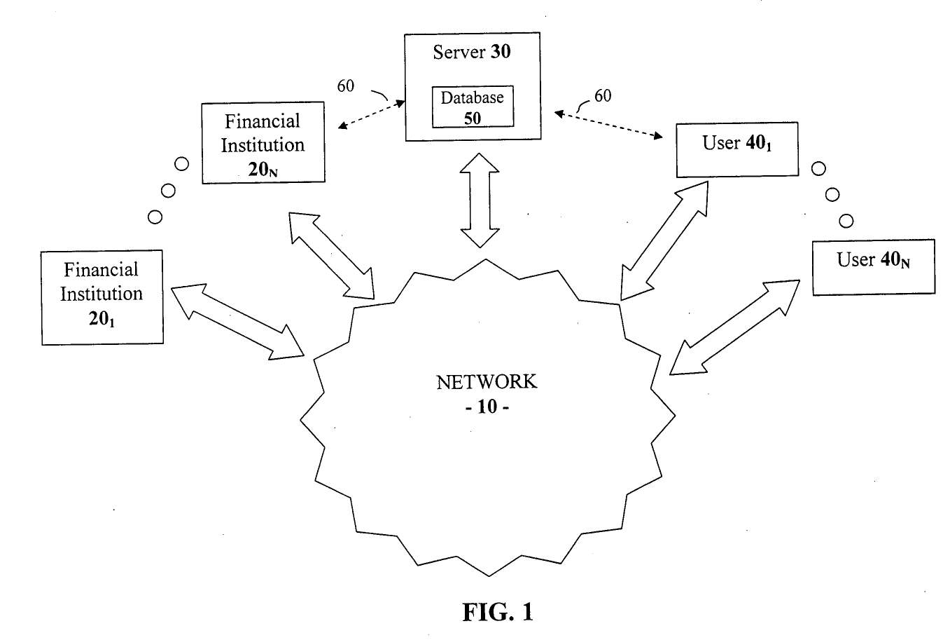

Referring to FIG. 1, one embodiment of a system in which access to debt payment information may be provided is depicted. The system of FIG. 1 comprises a network 10 which connects one or more financial institutions 20₁-20_{N} (“20”), server 30 and one or more users 40₁-40_{N} (“40”). It should be appreciated that network 10 may be any type of network, including a wide area network (e.g., Internet), local area network, and combinations thereof. It should further be appreciated that financial institutions 20 may include any entity which maintains debt-related information. For example, this would include banks, credit unions, other types of lending institutions, accounting intermediaries, loan servicing entities, and the like. Similarly, users 40 may include any type of retailer (e.g., car dealer, boat dealer, mortgage company, etc.), as well as the consumers themselves.

In one embodiment, server 30 (e.g., connected to the World Wide Web) is accessible over network 10 by financial institutions 20 and/or users 40. In the embodiment of FIG. 1, server 30 includes database 50, where database 50 may be used to maintain loan information that has been provided to server 30 by financial institutions 20. In another embodiment, server 30 further includes software modules that may be executed and/or downloaded for performing the processes disclosed herein. Server 30 may also be comprised of one or more individual computers (not shown).

In still a further embodiment, server 30 (and hence database 50) may be accessed by financial institutions 20 and/or users 40 via connections 60, which in one embodiment is a telephone line connection. In such an embodiment, financial institutions 20 and/or users 40 may use a telephone menuing system to access the aforementioned payoff information. Connections 60 may similarly include any other direct connection capable of transmitting data between server 30, on the one hand, and financial institutions 20 and users 40, on the other hand.

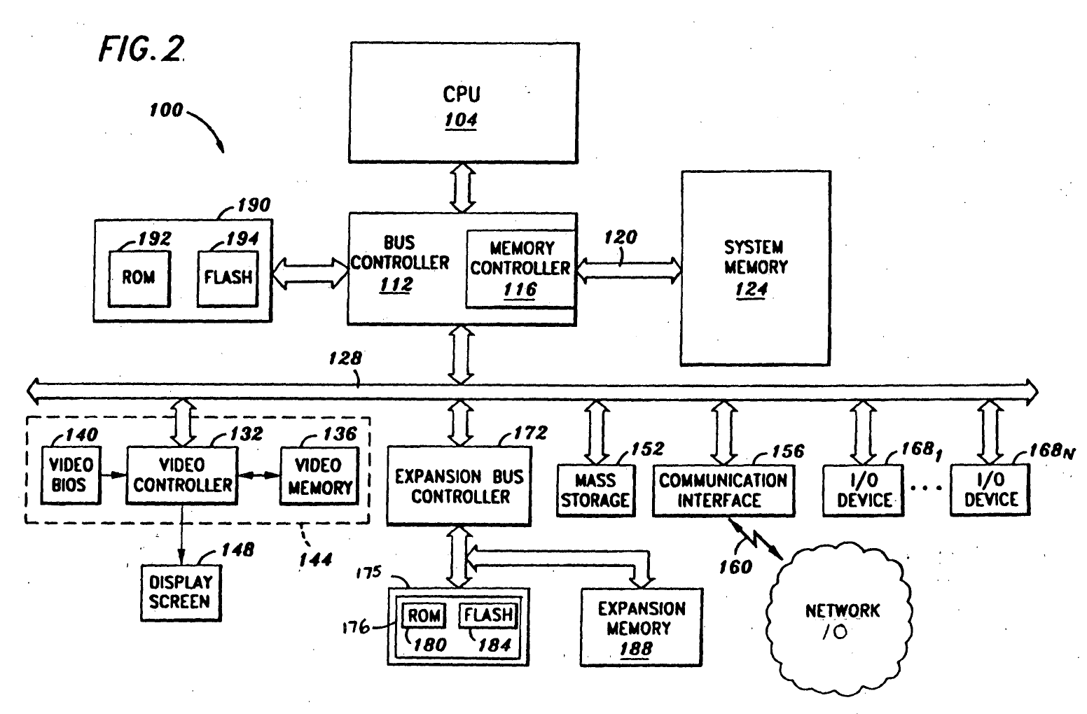

Financial institutions 20 and/or users 40 may be coupled to the remote network 10 using one or more computer system(s) 100, which will be described in more detail below with reference to FIG. 2. Computer systems 100 may be any type of computer system or other device that processes and/or presents video information. Computer system(s) 100 may connect financial institutions 20 and/or users 40 to network 10 via known network connections over a corresponding communication link, such as a local carrier exchange to a respective internet service provider (ISP). In the embodiment where server 30 is accessible through a website, the URL address of the target website may be used to connect to server 30 and database 50. While a description of all of the methods by which financial institutions 20 and/or users 40 may connect to server 30 is beyond the scope of the present disclosure, it should be appreciated that all such known methods may be similarly used.

As previously mentioned, financial institutions 20 and/or users 40 may access server 30 (and hence database 50) using one or more computer systems. To that end, FIG. 2 is representative of one embodiment of a computer system 100 which may be used to connect to server 30 via network 10, or directly via connection 60. As discussed herein, a “computer system” is a product including circuitry capable of processing data. The computer system may include, but is not limited to, general purpose computer systems (e.g., server, laptop, desktop, palmtop, personal electronic devices, etc.), personal computers (PCs), hard copy equipment (e.g., printer, plotter, fax machine, etc), and the like. The computer system 100 comprises a processor or a central processing unit (CPU) 104. The illustrated CPU 104 includes an Arithmetic Logic Unit (ALU) for performing computations, a collection of registers for temporary storage of data and instructions, and a control unit for controlling operation for the system 100. The CPU 104 is not limited to microprocessor but may take on other forms such as microcontrollers, digital signal processors, reduced instruction set computers (RISC), application specific integrated circuits, and the like. Although shown with one CPU 104, computer system 100 may alternatively include multiple processing units.

The CPU 104 is coupled to a bus controller 112 by way of a CPU bus 108. Bus controller 112 provides an interface between the CPU 104 and memory 124 via memory bus 120. Moreover, bus controller 112 provides an interface between memory 124, CPU 104 and other devices coupled to system bus 128. It should be appreciated that memory 124 may be system memory, such as synchronous dynamic random access memory (SDRAM) or may be another form of volatile memory. It should further be appreciated that memory 124 may include non-volatile memory, such as ROM or flash memory. System bus 128 may be a peripheral component interconnect (PCI) bus, Industry Standard Architecture (ISA) bus, etc. Coupled to the system bus 128 are a video controller 132, a mass storage device 152, a communication interface device 156, and one or more input/output (I/O) devices 168₁-168_{N}. The video controller 132 controls display data for displaying information on the display screen 148. In another embodiment, the video controller 132 is coupled to the CPU 104 through an Advanced Graphics Port (AGP) bus.

The mass storage device 152 includes (but is not limited to) a hard disc, floppy disc, CD-ROM, DVD-ROM, tape, high density floppy, high capacity removable media, low capacity removable media, solid state memory device, etc., and combinations thereof. The mass storage device 152 may include any other mass storage medium. The communication interface device 156 includes a network card, a modem interface, etc. for accessing network 164 via communications link 160. The I/O devices 168₁-168_{N} include a keyboard, mouse, audio/sound card, printer, and the like. The I/O devices 168₁-168_{N} may be disk drive, such as a compact disk drive, a digital disk drive, a tape drive, a zip drive, a jazz drive, a digital versatile disk (DVD) drive, a magneto-optical disk drive, a high density floppy drive, a high capacity removable media drive, a low capacity media device, and/or any combination thereof.

In accordance with the practices of persons skilled in the art of computer programming, the present disclosure is described below with reference to symbolic representations of operations that are performed by computer system 100, unless indicated otherwise. Such operations are sometimes referred to as being computer-executed. It will be appreciated that operations that are symbolically represented include the manipulation by CPU 104 of electrical signals representing data bits and the maintenance of data bits at memory locations in memory 124, as well as other processing of signals. The memory locations where data bits are maintained are physical locations that have particular electrical, magnetic, optical, or organic properties corresponding to the data bits.

When implemented in software, the elements of the present disclosure are essentially the code segments to perform the necessary tasks. The program or code segments can be stored in a processor readable medium or transmitted by a computer data signal embodied in a carrier wave over a transmission medium or communication link. The “processor readable medium” or “machine-readable medium” may include any medium that can store or transfer information. Examples of the processor readable medium include an electronic circuit, a semiconductor memory device, a ROM, a flash memory, an erasable ROM (EROM), a floppy diskette, a CD-ROM, a DVD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

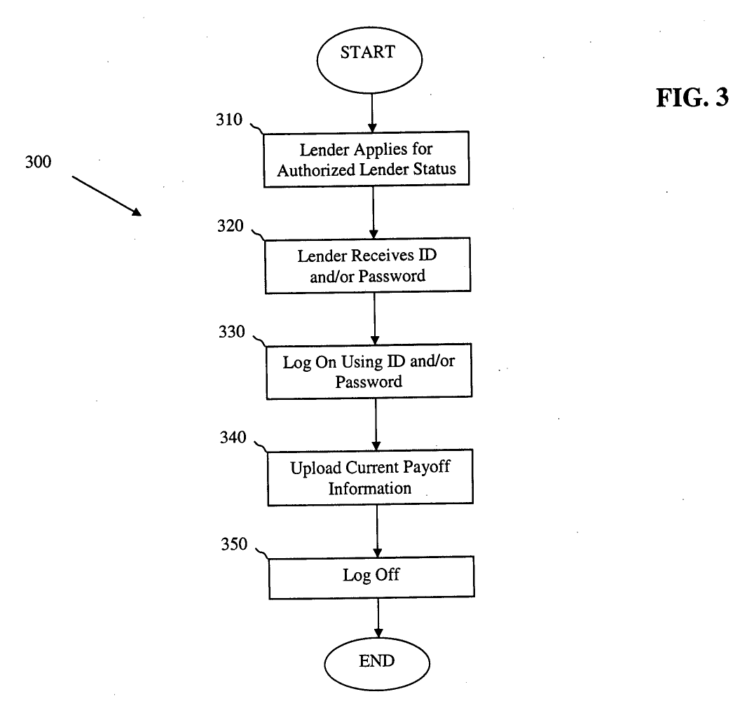

Referring now to FIG. 3, one embodiment of a process for providing loan payoff information to server 30 is shown. In particular, process 300 begins at block 310 when the lender/financial institution applies for status as an authorized financial institution. While the particulars of the application process are beyond the scope of this disclosure, it should be appreciated that numerous procedures may be followed and be consistent with the principles disclosed herein. While it is also possible to carry out the invention without performing the authorization procedures of blocks 310, such procedures may be desirable to ensure the security and integrity of the information.

Once the lender in question has been approved, process 300 moves to block 320 where the lender receives an identification number (ID) and/or a password. This ID and/or password may then be used to log on to server 30 at block 330. As described above, this log on process may be via network 10, or directly via connection 60. Once logged in, the lender may then proceed to upload customer loan information to database 50 (block 340). Process 300 then terminates once the customer loan information is uploaded and the lender logs off of the system at block 350. Each lender/financial institution may perform 330-350 periodically (e.g., weekly, every 10 days, etc.) to provide current and up-to-date loan payoff information. Such information may be accessible to the debtor and entities authorized by the debtor at virtually any time.

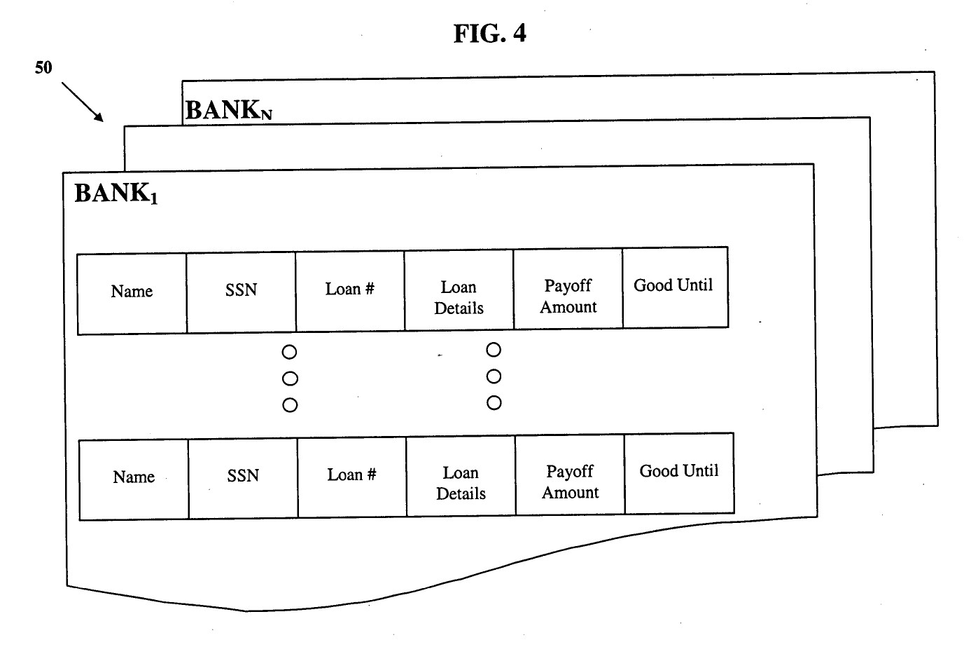

Referring now to FIG. 4, one embodiment of database 50 is depicted. Although other known database structures may be used, the database of FIG. 4 is divided into individual records for each of banks (or lending entities) 1-N. In turn, each record contains loan payoff information for that particular institution's customers. In the embodiment of FIG. 4, such customer information includes the customer's name, social security number, loan number, miscellaneous loan details, the payoff amount, and a date until which the payoff amount is valid. It should of course be appreciated that other information may similarly be included, or that some of the shown information omitted. In one embodiment, database 50 is maintained in a mass storage device, such as mass storage 152 (FIG. 2).

The server 30, which may include a computer system 100 as shown in FIG. 2, includes appropriate software for interfacing with financial institutions 20 to allow periodic upload of loan payoff information. Server 30 also includes appropriate software for providing access to debtor's records in database 50 to users 40, preferably to a plurality of users 40 at the same time.

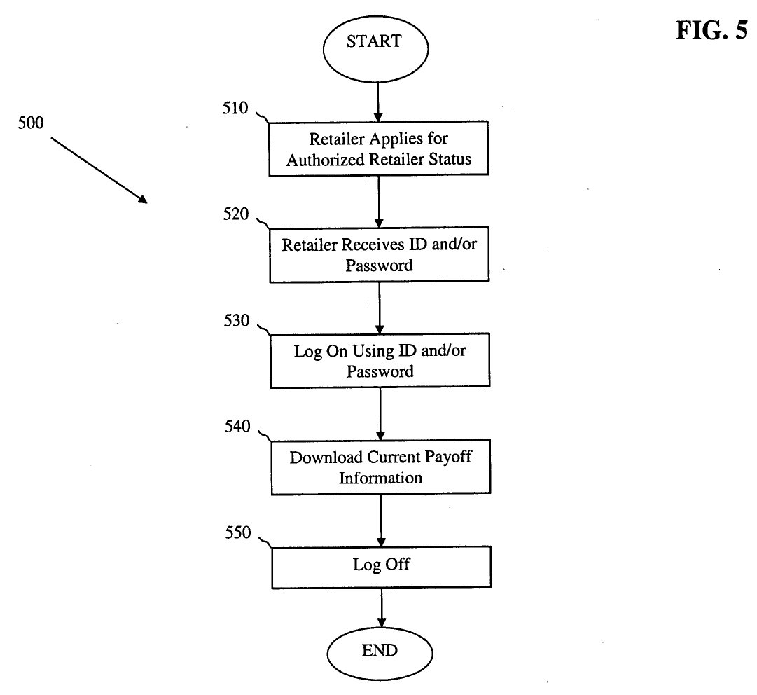

With reference to FIG. 5, suppose that retailer is a car dealer who has been approached by a potential customer to purchase a new vehicle. If the potential customer is also seeking to trade in a vehicle, consummating the transaction may require that the dealer obtain current and correct payoff information for the potential customer's current vehicle. If this transaction is to take place during non-traditional business hours (e.g., the weekend, holiday, etc.), it is not typically possible or practical to obtain such payoff information from the lending institution. In such cases, the potential customer is often time asked to estimate the payoff amount. Based on this estimate, a contingent contract may be drawn up. However, if the estimation was inaccurate, which is often the case, the transaction may be voided by the dealer and/or the potential customer. To that end, FIG. 5 depicts one embodiment of a process for providing a retailer with access, at any time, to up-to-date loan payoff information from a centralized database, such as database 50.

Process 500 begins when a retailer applies to become an authorized retailer at block 510. As with the authorization process of FIG. 3, it should be appreciated that numerous known authorization/authentication procedures may be followed and still be consistent with the principles of the invention. Once the optional authorization process is completed, the retailer is provided with an ID and/or password (block 520). Using the provided ID and/or password, the retailer may then log on to server 30 (and hence database 50) at block 530, with the consent of the customer. At this point, the retailer may choose to download the desired payoff information from server 30 (block 540). In an alternate embodiment, rather than download the information from server 30 to a computer system, such as system 100 (FIG. 2) the retailer may use connection 60 to access the payoff information stored in database 50 using a telephone menuing system. Once the retailer has obtained the desired information, process 500 terminates with the retailer logging off at block 550.

While FIG. 5 relates to retailer access of payoff information, it may also be applied to consumer access of payoff information. Thus, rather than user 40 being the retailer, the user 40 would be the consumer to which the loan information relates. However, where consumers are provided with access to database 50, in one embodiment they are provided with limited access to only their own loan information. In contrast, authorized retailers may be provided with access to all loan information, according to one embodiment.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A method of centralizing access to vehicle debt payoff information, comprising:
uploading current vehicle debt payoff information to a database on a server computer system from computer systems of a plurality of lending institutions, said database including a plurality of records for each of said plurality of lending institutions, wherein said plurality of records includes borrower identification and vehicle debt payoff information for a respective plurality of borrowers;
updating said current vehicle debt payoff information periodically; and
accessing a portion of said current vehicle debt payoff information from said database by a vehicle dealership, said portion of said current vehicle debt payoff information including said borrower identification and current loan amount.

2. The method of claim 1, wherein said accessing the portion of said current vehicle debt payoff information comprising accessing the portion of said current vehicle debt payoff information by accessing said database over an Internet connection.

3. The method of claim 1, wherein said accessing the portion of said current vehicle debt payoff information comprising accessing the portion of said current vehicle debt payoff information by accessing said database over a telephone line connection.

4. The method of claim 1 further comprising, prior to said uploading current vehicle debt payoff information, authenticating one or more of said plurality of lending institutions as being authorized lending institutions.

5. The method of claim 1, wherein said current vehicle debt payoff information is used by the vehicle dealership in the preparation of a vehicle contract involving one of said plurality of borrowers.

6. The method of claim 1, wherein said updating said current vehicle debt payoff information periodically comprises updating said current vehicle debt payoff information periodically where the periodic update of one lending institution is different from the periodic update of other lending institutions.

7. The method of claim 1, wherein said updating said current vehicle debt payoff information periodically comprises updating said current vehicle debt payoff information by said plurality of lending institutions at different periodic intervals.

8. A system for accessing vehicle debt payoff information from a centralized database, comprising:
means for uploading current vehicle debt payoff information to a database by a plurality of lending institutions, said database including a plurality of records for each of said plurality of lending institutions, wherein said plurality of records includes borrower identification information and vehicle debt payoff information for a plurality of borrowers;
means for periodically updating said current vehicle debt payoff information; and
means for accessing a portion of said current vehicle debt payoff information from said database by a vehicle dealership, said portion of said current vehicle debt payoff information includes a borrower's name, loan number, and payoff amount.

9. The system of claim 8, wherein said means for accessing the portion of said current vehicle debt payoff information comprising means for accessing the portion of said current vehicle debt payoff information using means for accessing said database over a network connection.

10. The system of claim 8, wherein said means for accessing the portion of said current vehicle debt payoff information comprising means for accessing the portion of said current vehicle debt payoff information using means for accessing said database over a telephone line connection.

11. The system of claim 8 further comprising, prior to said means for uploading current vehicle debt payoff information, means for authenticating said plurality of lending institutions as being authorized lending institutions.

12. The system of claim 8, wherein said current vehicle debt payoff information is used by the vehicle dealership in the preparation of a vehicle contract involving one of said plurality of borrowers.

13. The system of claim 8, wherein said means for periodically updating said current vehicle debt payoff information comprises means for periodically updating said current vehicle debt payoff information by said plurality of lending institutions at different periodic intervals.
